(19) United States
(12) Patent Application Publication
(10) Pub. No.: US 2007/0025119 A1
(43) Pub. Date: Feb. 1, 2007

(54) [LED MODULE]

(75) Inventors: Wen-Jack Chang-Jien, TAIPEI (TW); Ming-Chung Huang, TAIPEI (TW); Yu-Yang Liu, TAIPEI (TW)

Correspondence Address: LEDTECH ELECTRONICS CORP., P.O. BOX 108-00403, TAIPEI, TW

(73) Assignee: LEDTECH ELECTRONICS CORP., Hsin-Tien City, Taipei Hsien (TW)

(21) Appl. No.: 11/161,357

(22) Filed: Aug. 1, 2005

(51) Int. Cl. F21V 7/04

(52) U.S. Cl. 362/555; 362/551

(57) ABSTRACT

An LED module is disclosed to include a light guide tube, two LEDs provided at the two ends of the light guide tube, a reflector strip, which has an arched reflecting surface for reflecting light from the LEDs, and a converter for converting input power supply to the desired working voltage level for the LEDs.

### BACKGROUND OF THE INVENTION

1. Field of the Invention

The present invention relates to modules and more particularly, to a LED module, which uses an arched reflector strip in a light guide tube for reflecting light from LEDs at the ends of the light guide tube.

2. Description of the Related Art

The invention of lamp greatly changes the style of building construction and the living style of human beings, allowing people to work during the night. Without the invention of lamp, we may stay in the old living conditions of ancient civilization.

Various lamps such as incandescent bulbs, fluorescent bulbs, power-saving bulbs and etc. have been intensively used for indoor illumination. These lamps commonly have the disadvantages of quick attenuation, high consumption of power supply, high production of heat, short working life, high fragility, and being not reclaimable. Further, the quick flowing of electrons (about 120 per second) through the electrodes of a regular fluorescent bulb causes an unstable current at the beginning of starting the fluorescent bulb, resulting in a flashing of light that is harmful to the sight of the eyes. In order to eliminate this problem, a high frequency electronic ballast may be used. When a fluorescent or power-saving bulb is used with high frequency electronic ballast, it saves about 20% of the consumption of power and eliminates the problem of flashing. However, the high frequency electronic ballast is not detachable when installed in a fluorescent or power-saving bulb, the whole lamp assembly becomes useless if the bulb is damaged. Further, because a fluorescent bulb contains a mercury coating, it may cause pollution to the environment when thrown away after damage.

Therefore, it is desirable to provide a lamp that eliminates the aforesaid problems.

### SUMMARY OF THE INVENTION

The present invention has been accomplished under the circumstances in view. It is therefore the main object of the present invention to provide a LED module, which saves power consumption and eliminates the problems of unstable current, flashing and dazzling. To achieve this and other objects of the present invention, the LED module comprises a light guide tube, two LEDs (light emitting diodes) provided at the two distal ends of the light guide tube and adapted to emit light into the inside of the light guide tube, and a reflector strip mounted inside the light guide tube for reflecting light from the LEDs.

### BRIEF DESCRIPTION OF THE DRAWINGS

FIG. 1 is a perspective exploded view of a LED module according to a first embodiment of the present invention.

FIG. 2 is a block diagram of the LED module according to the present invention.

FIG. 3 is a block diagram of a LED module according to a second embodiment of the present invention.

FIG. 4 is a schematic drawing showing different forms of LED modules according to the second embodiment of the present invention.

FIG. 5 is a block diagram of a LED module according to a third embodiment of the present invention.

### DETAILED DESCRIPTION OF THE PREFERRED EMBODIMENT

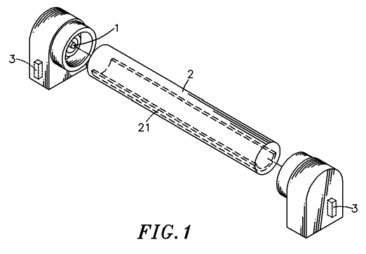

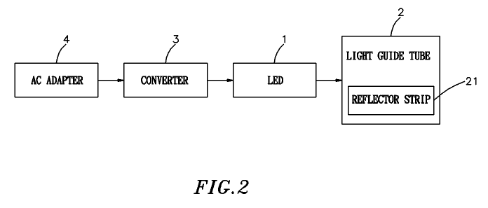

Referring to FIGS. 1 and 2, a LED module in accordance with the first embodiment of the present invention is shown comprised of a plurality of LEDs (light emitting diodes) 1, a light guide tube 2, and a converter 3.

The LEDs 1 are symmetrically provided at the two distal ends of the light guide tube 2 and adapted to emit light into the light guide tube 2.

The light guide tube 2 is a tubular member made of a transparent or semi-transparent material, having a reflector strip 21 of arched cross section adhered to the inside wall thereof for reflecting light from the LEDs 1. The light guide tube 2 and the reflector strip 21 may be made of different materials.

The converter 3 is electrically connected to the LEDs 1, and adapted to convert input power supply obtained through an AC adapter 4 into the desired working voltage level for the LEDs 1. The converter 3 can be an AC/DC transformer.

When in use, the LEDs 1 are provided at the two distal ends of the light guide tube 2, and the converter 3 converts power supply obtained from the AC adapter 4 to the desired working voltage level for driving the LEDs 1, causing the LEDs 1 to emit light into the light guide tube 2 from the two ends of the light guide tube 2. A light ray goes straight in an interface. When going through two different interfaces, a part of the light ray will be reflected onto one same interface. According to the law of reflection, a light ray incident upon a reflective surface will be reflected at an angle equal to the incident angle. A light ray incident upon an inwardly curved surface will be reflected to enhance the light intensity. Therefore, when light rays entered the light guide tube 2, the reflector strip 21 reflects incident light rays, enhancing the light intensity.

In the aforesaid embodiment, LEDs 1 are symmetrically provided at the two distal ends of the light guide tube 2. Alternatively, one or a set of LEDs 1 can be provided only at one end of the light guide tube 2.

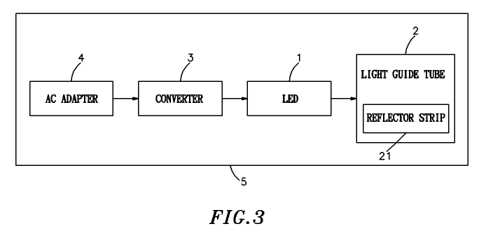

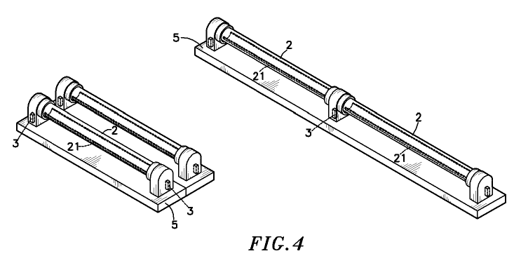

FIGS. 3 and 4 show an alternate form of the present invention. According to this embodiment, the LEDs 1, the light guide tube 2 and the converter 3 are modularized and positioned on a lamp holder 5. Further, multiple LED modules can be connected in series or parallel and arranged on a common or respective lamp holder 5.

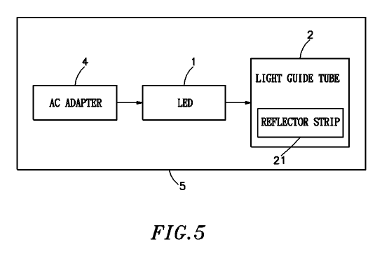

FIG. 5 is a block diagram of another alternate form of the present invention. According to this embodiment, the aforesaid converter 3 is eliminated, and the AC adapter 4 is directly connected to the LEDs 1 to provide the LEDs 1 with the necessary working voltage.

As indicated above, the invention uses LEDs 1 to produce light for the advantages of zero warm-up time, quick response speed, small size, low power consumption, low pollution, high brightness, and high durability. The LEDs 1 emit light toward the inside of the light guide tube 2, and the smoothly arched reflecting surface of the reflector strip 21 reflects light rays in predetermined directions, making the light guide tube 2 luminous and enhancing the brightness of the light. Therefore, the invention can be used as a regular lamp without high frequency electronic ballast for indoor illumination that eliminates the problem of unstable current, flashing and dazzling as encountered in regular fluorescent bulbs. When damaged, the LED module can still be used normally after replacement of the damaged LED(s).

A prototype of LED module has been constructed with the features of FIGS. 1˜5. The LED module functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An LED module comprising:
a light guide tube;
at least one LED (light emitting diode) each provided at one end of said light guide tube and adapted to emit light into the inside of said light guide tube;
a reflector strip mounted inside said light guide tube, said reflector strip having an arched reflecting surface for reflecting light from said at least one LED; and
converter means electrically connected to said at least one LED and adapted to convert input power supply into a predetermined working voltage for said at least one LED.

2. The LED module as claimed in claim 1, wherein said light guide tube is made of a transparent material.

3. The LED module as claimed in claim 1, wherein said light guide tube is made of a semi-transparent material.

4. The LED module as claimed in claim 1, wherein said light guide tube and said reflector strip are made of different materials, and said reflector strip is formed integral with an inside wall of said light guide tube.

5. The LED module as claimed in claim 1, wherein said converter means is an AC to DC converter.

6. An LED module comprising:
a light guide tube;
at least one LED (light emitting diode) each provided at one end of said light guide tube and adapted to emit light into the inside of said light guide tube;
a reflector strip disposed inside said light guide tube, said reflector strip having an arched reflecting surface for reflecting light from said at least one LED; converter means electrically connected to said at least one LED and adapted to convert input power supply into a predetermined working voltage for said at least one LED; and
a lamp holder that holds said light guide tube, said at least one LED and said converter means.

7. The LED module as claimed in claim 6, wherein said light guide tube is made of a transparent material.

8. The LED module as claimed in claim 6, wherein said light guide tube is made of a semi-transparent material.

9. The LED module as claimed in claim 6, wherein said light guide tube and said reflector strip are made of different materials, and said reflector strip is formed integral with an inside wall of said light guide tube.

10. The LED module as claimed in claim 6, wherein said converter means is an AC to DC converter.

11. A LED module comprising:
a light guide tube;
a plurality of LEDs (light emitting diodes) respectively disposed at two distal ends of said light guide tube and adapted to emit light into the inside of said light guide tube;
a reflector strip mounted inside said light guide tube, said reflector strip having an arched reflecting surface for reflecting light from said LEDs;
an AC adapter adapted to convert AC power supply into DC power supply for the working of said LEDs; and
a lamp holder, which holds said light guide tube, said AC adapter and said LEDs in place.

12. The LED module as claimed in claim 11, wherein said light guide tube is made of a transparent material.

13. The LED module as claimed in claim 11, wherein said light guide tube is made of a semi-transparent material.

14. The LED module as claimed in claim 11, wherein said light guide tube and said reflector strip are made of different materials, and said reflector strip is formed integral with an inside wall of said light guide tube.
